(19) United States
(12) Patent Application Publication
(10) Pub. No.: US 2021/0092424 A1
(43) Pub. Date: Mar. 25, 2021

(54) ADAPTIVE FRAMERATE FOR AN ENCODER

(71) Applicant: ATI Technologies ULC, Markham (CA)

(72) Inventors: Guennadi Riguer, Markham (CA); Ihab M. A. Amer, Markham (CA)

(73) Assignee: ATI Technologies ULC, Markham (CA)

(21) Appl. No.: 16/579,825

(22) Filed: Sep. 23, 2019

(51) Int. Cl. H04N 19/46; H04N 19/513; H04N 19/156; H04N 19/146

(52) U.S. Cl. CPC H04N 19/46; H04N 19/146; H04N 19/156; H04N 19/513

(57) ABSTRACT

A technique for generating encoded video in a client-server system is provided. According to the technique, a server determines that reprojection analysis should occur. The server generates reprojection metadata based on suitability of video content to reprojection. The server generates encoded video based on the reprojection metadata, and transmits the encoded video to a client for display. The client reprojects video content as directed by the server.

### BACKGROUND

In a remote video generation and delivery system, such as cloud gaming, a server generates and encodes video for transmission to a client, which decodes the encoded video for display to a user. Improvements to remove video encoding are constantly being made.

### BRIEF DESCRIPTION OF THE DRAWINGS

A more detailed understanding is gained from the following description, given by way of example in conjunction with the accompanying drawings wherein:

FIG. 1A is a block diagram of a remote encoding system, according to an example;

FIG. 1B is a block diagram of an example implementation of the server;

FIG. 1C is a block diagram of an example implementation of the client;

FIG. 2A presents a detailed view of the encoder of FIG. 1, according to an example;

FIG. 2B represents a decoder for decoding compressed data generated by an encoder such as the encoder, according to an example;

FIG. 3 is a block diagram of the remote encoding system of FIG. 1A, illustrating additional details related to dynamic framerate adjustment at the server and reprojection at the client, according to an example; and

FIG. 4 is a flow diagram of a method for setting the framerate for an encoded video stream, according to an example.

### DETAILED DESCRIPTION

A technique for interactive generation of encoded video is provided. According to the technique, a server determines that reprojection analysis should occur. The server generates reprojection metadata based on suitability of video content to reprojection. The server generates encoded video based on the reprojection metadata, and transmits the encoded video and reprojection metadata to a client for display.

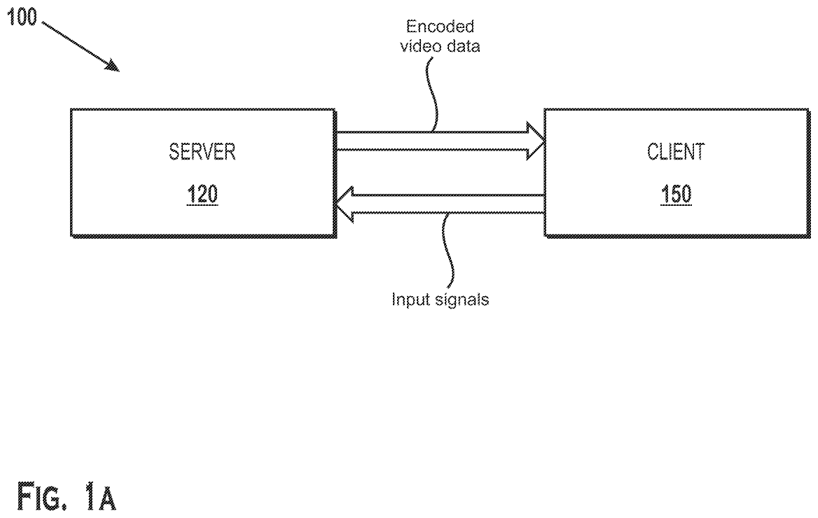

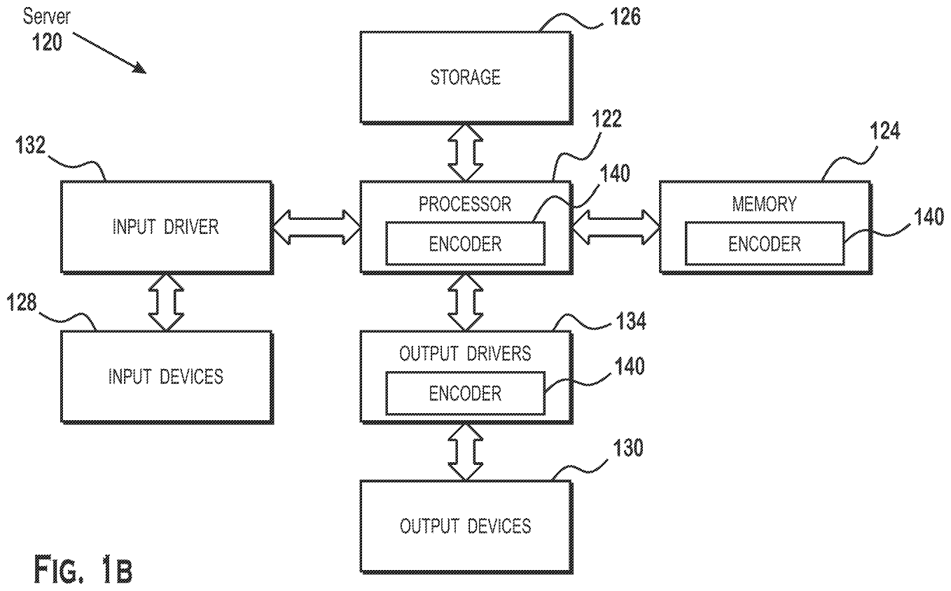

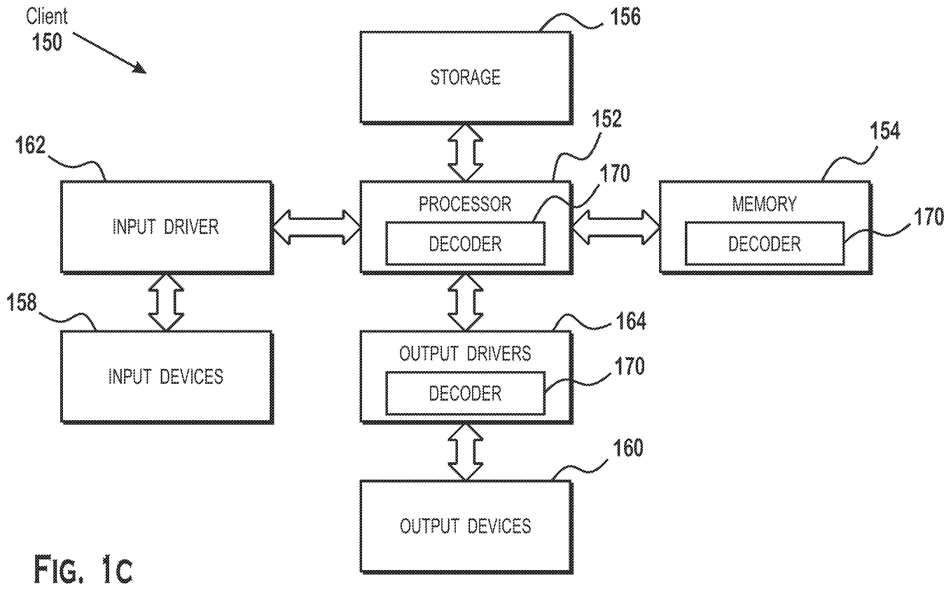

FIG. 1A is a block diagram of a remote encoding system 100, according to an example. A server 120 and a client 150, which are both computing devices, are included in the system. In various implementations, the remote encoding system 100 is any type of system where the server 120 provides encoded video data to a remote client 150. An example of such a system is a cloud gaming system. Another example is a media server.

In operation, the server 120 encodes generated graphics data in a video format such as MPEG-4, AV1, or any other encoded media format. The server 120 accepts user input from the client 150, processes the user input according to executed software, and generates graphics data. The server 120 encodes the graphics data to form encoded video data, which is transmitted to the client 150. The client 150 displays the encoded video data for a user, accepts inputs, and transmits the input signals to the server 120.

FIG. 1B is a block diagram of an example implementation of the server 120. It should be understood that although certain details are illustrated, a server 120 of any configuration that includes an encoder 140 for performing encoding operations in accordance with the present disclosure is within the scope of the present disclosure.

The server 120 includes a processor 122, a memory 124, a storage device 126, one or more input devices 128, and one or more output devices 130. The device optionally includes an input driver 132 and an output driver 134. It is understood that the device optionally includes additional components not shown in FIG. 1B.

The processor 122 includes one or more of: a central processing unit (CPU), a graphics processing unit (GPU), a CPU and GPU located on the same die, or one or more processor cores, wherein each processor core is a CPU or a GPU. The memory 124 is located on the same die as the processor 122 or separately from the processor 122. The memory 124 includes a volatile or non-volatile memory, for example, random access memory (RAM), dynamic RAM, or a cache.

The storage device 126 includes a fixed or removable storage, for example, a hard disk drive, a solid state drive, an optical disk, or a flash drive. The input devices 128 include one or more of a keyboard, a keypad, a touch screen, a touch pad, a detector, a microphone, an accelerometer, a gyroscope, or a biometric scanner. The output devices 130 include one or more of a display, a speaker, a printer, a haptic feedback device, one or more lights, or an antenna.

The input driver 132 communicates with the processor 122 and the input devices 128, and permits the processor 122 to receive input from the input devices 128. The output driver 134 communicates with the processor 122 and the output devices 130, and permits the processor 122 to send output to the output devices 130.

A video encoder 140 is shown in two different alternative forms. In a first form, the encoder 140 is software that is stored in the memory 124 and that executes on the processor 122 as shown. In a second form, the encoder 140 is at least a portion of a hardware video engine (not shown) that resides in output drivers 134. In other forms, the encoder 140 is a combination of software and hardware elements, with the hardware residing, for example, in output drivers 134, and the software executed on, for example, the processor 122.

Note that although some example input devices 128 and output devices 130 are described, it is possible for the server 120 to include any combination of such devices, to include no such devices, or to include some such devices and other devices not listed.

FIG. 1C is a block diagram of an example implementation of the client 150. This example implementation is similar to the example implementation of the server 120, but the client 150 includes a decoder 170 instead of an encoder 140. Note that the illustrated implementation is just an example of a client that receives and decodes video content, and that in various implementations, any of a wide variety of hardware configurations are used in a client that receives and decodes video content from the server 120.

The client 150 includes a processor 152, a memory 154, a storage device 156, one or more input devices 158, and one or more output devices 160. The device optionally includes an input driver 162 and an output driver 164. It is understood that the device optionally includes additional components not shown in FIG. 1C.

The processor 152 includes one or more of: a central processing unit (CPU), a graphics processing unit (GPU), a CPU and GPU located on the same die, or one or more processor cores, wherein each processor core is a CPU or a GPU. The memory 154 is located on the same die as the processor 152 or separately from the processor 152. The memory 154 includes a volatile or non-volatile memory, for example, random access memory (RAM), dynamic RAM, or a cache.

The storage device 156 includes a fixed or removable storage, for example, a hard disk drive, a solid state drive, an optical disk, or a flash drive. The input devices 158 include one or more of a keyboard, a keypad, a touch screen, a touch pad, a detector, a microphone, an accelerometer, a gyroscope, or a biometric scanner. The output devices 160 include one or more of a display, a speaker, a printer, a haptic feedback device, one or more lights, or an antenna.

The input driver 162 communicates with the processor 152 and the input devices 158, and permits the processor 152 to receive input from the input devices 158. The output driver 164 communicates with the processor 152 and the output devices 160, and permits the processor 152 to send output to the output devices 130.

A video decoder 170 is shown in two different alternative forms. In a first form, the decoder 170 is software that is stored in the memory 154 and that executes on the processor 152 as shown. In a second form, the decoder 170 is at least a portion of a hardware graphics engine that resides in output drivers 164. In other forms, the decoder 170 is a combination of software and hardware elements, with the hardware residing, for example, in output drivers 164, and the software executed on, for example, the processor 152.

Although an encoder 140, and not a decoder, is shown in the server 120 and a decoder 170, and not an encoder, is shown in the client 150, it should be understood that in various implementations, either or both of the client 150 and the server 120 include both an encoder and a decoder.

Note that although some example input devices 158 and output devices 160 are described, it is possible for the client 150 to include any combination of such devices, to include no such devices, or to include some such devices and other devices not listed.

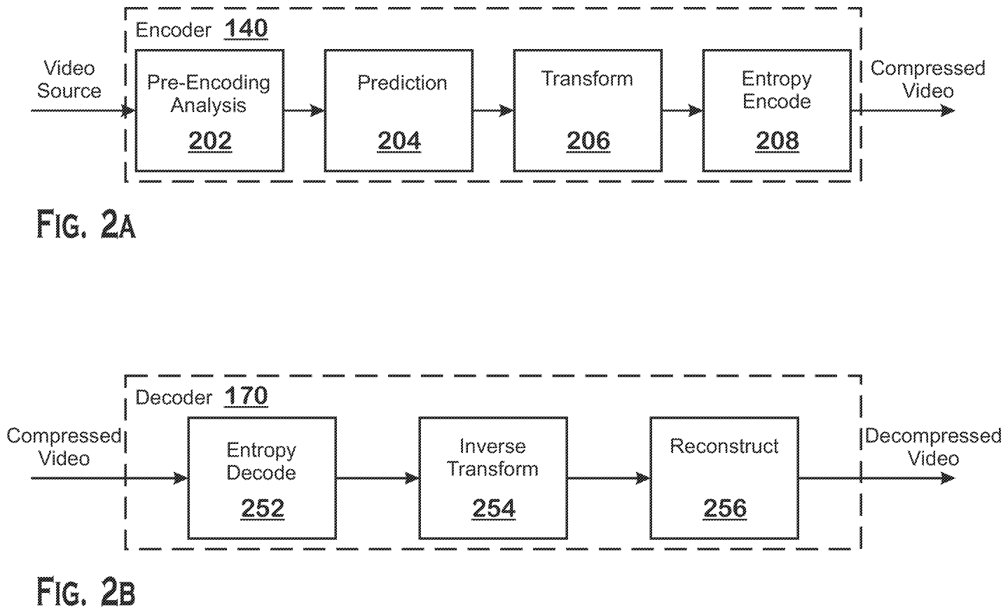

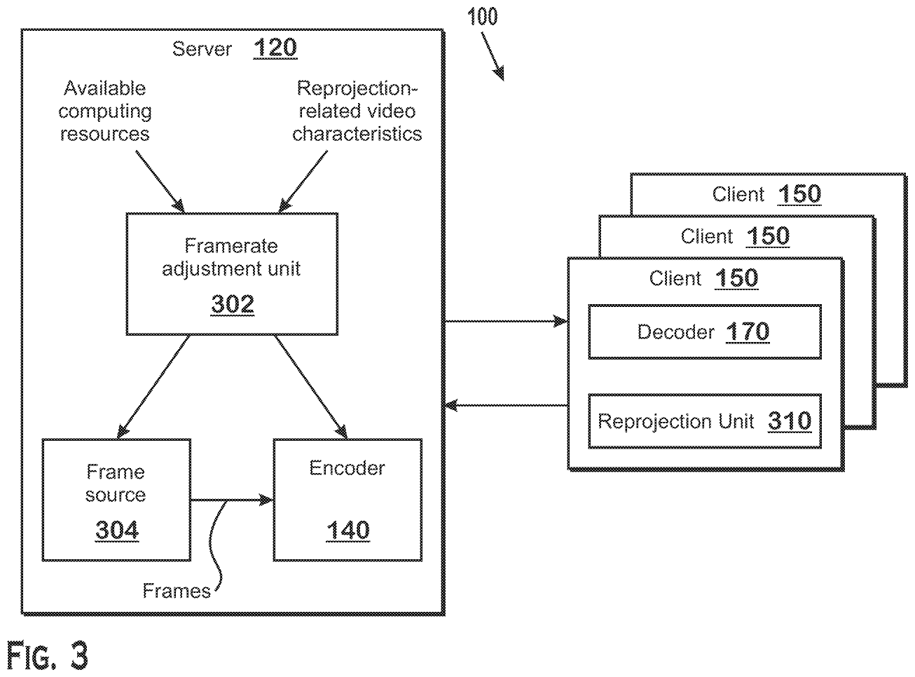

FIG. 2A presents a detailed view of the encoder 140 of FIG. 1, according to an example. The encoder 140 accepts source video, encodes the source video to produce compressed video (or “encoded video”), and outputs the compressed video. In various implementations, the encoder 140 includes blocks other than those shown. The encoder 140 includes a pre-encoding analysis block 202, a prediction block 204, a transform block 206, and an entropy encode block 208. In some alternatives, the encoder 140 implements one or more of a variety of known video encoding standards (such as MPEG2, H.264, or other standards), with the prediction block 204, transform block 206, and entropy encode block 208 performing respective portions of those standards. In other alternatives, the encoder 140 implements a video encoding technique that is not a part of any standard.

The prediction block 204 performs prediction techniques to reduce the amount of information needed for a particular frame. Various prediction techniques are possible. One example of a prediction technique is a motion prediction based inter-prediction technique, where a block in the current frame is compared with different groups of pixels in a different frame until a match is found. Various techniques for finding a matching block are possible. One example is a sum of absolute differences technique, where characteristic values (such as luminance) of each pixel of the block in the current block is subtracted from characteristic values of corresponding pixels of a candidate block, and the absolute values of each such difference are added. This subtraction is performed for a number of candidate blocks in a search window. The candidate block with a score deemed to be the “best,” such as by having the lowest sum of absolute differences, is deemed to be a match. After finding a matching block, the current block is subtracted from the matching block to obtain a residual. The residual is further encoded by the transform block 206 and the entropy encode block 208 and the block is stored as the encoded residual plus the motion vector in the compressed video.

The transform block 206 performs an encoding step which is typically lossy, and converts the pixel data of the block into a compressed format. An example transform that is typically used is a discrete cosine transform (DCT). The discrete cosine transform converts the block into a sum of weighted visual patterns, where the visual patterns are distinguished by the frequency of visual variations in two different dimensions. The weights afforded to the different patterns are referred to as coefficients. These coefficients are quantized and are stored together as the data for the block. Quantization is the process of assigning one of a finite set of values to a coefficient. The total number of values that are available to define the coefficients of any particular block is defined by the quantization parameter (QP).

The entropy encode block 208 performs entropy coding on the coefficients of the blocks. Entropy coding is a lossless form of compression. Examples of entropy coding include context-adaptive variable-length coding and context-based adaptive binary arithmetic coding. The entropy coded transform coefficients describing the residuals, the motion vectors, and other information such as per-block QPs are output and stored or transmitted as the encoded video.

The pre-encoding analysis block 202 performs analysis on the source video to adjust parameters used during encoding. One operation performed by the pre-encoding analysis block 202 includes analyzing the source video to determine what quantization parameters should be afforded to the blocks for encoding.

FIG. 2B represents a decoder 170 for decoding compressed data generated by an encoder such as the encoder 140, according to an example. The decoder 170 includes an entropy decoder 252, an inverse transform block 254, and a reconstruct block. The entropy decoder 252 converts the entropy encoded information in the compressed video, such as compressed quantized transform coefficients, into raw (non-entropy-coded) quantized transform coefficients. The inverse transform block 254 converts the quantized transform coefficients into the residuals. The reconstruct block 256 obtains the predicted block based on the motion vector and adds the residuals to the predicted block to reconstruct the block.

Note that the operations described for FIGS. 2A and 2B only represent a small subset of the operations that encoder and decoders are capable of performing.

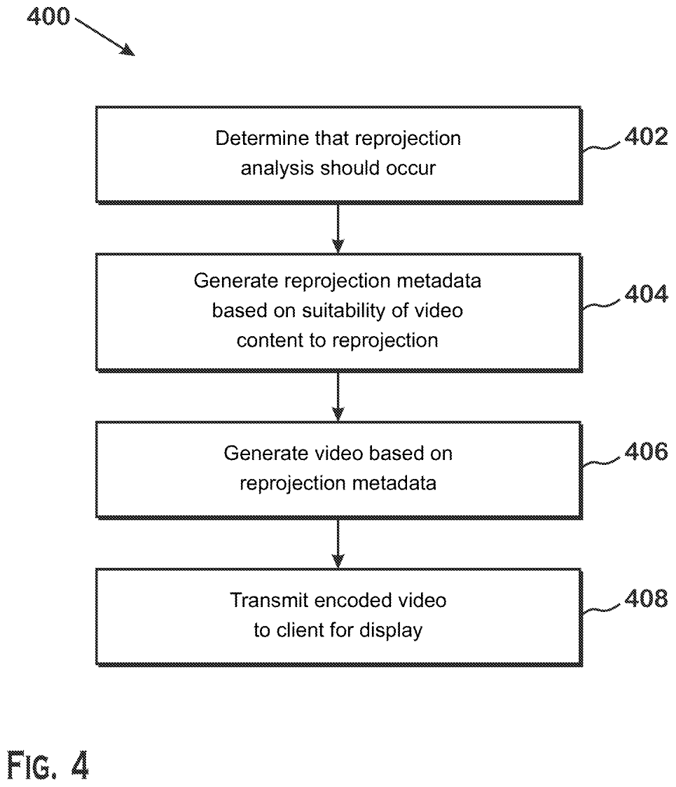

FIG. 3 is a block diagram of the remote encoding system 100 of FIG. 1A, illustrating additional details related to dynamic framerate adjustment at the server 120 and reprojection at the client 150, according to an example. A frame source 304 of the server either generates or receives frames to be encoded. Frames are raw video data. The frames are generated in any technically feasible manner. In an example, the frame source 304 is an element of the server 120 that generates the frames for encoding by the encoder 140. In various examples, the frame source 304 is a graphics processing unit that generates rendered frames from three-dimensional object data, a frame buffer that stores pixel data for the screen of a computer, or any other source that generates un-encoded frames. In other examples, the frame source 304 receives frames from an entity external to the server 120. In an example, the frame source 304 includes hardware and/or software for interfacing with a component such as another computing device that generates the frames or with a storage, buffer, or caching device that stores the frames.

The framerate adjustment unit 302 adjusts the framerate on the frame source 304 and/or the encoder 140. The framerate adjustment unit 302 is implemented fully in hardware (e.g., as one or more circuits configured to perform the functionality described herein), in software (e.g., as software or firmware executing on one or more programmable processors), or as a combination thereof (e.g, as one or more circuits that perform at least a part of the functionality of the framerate adjustment unit 302 working in conjunction with software or firmware executing on a processor that performs at least another part of the functionality of the framerate adjustment unit 302. In some examples where the frame source 304 generates frames, the framerate adjustment unit 302 adjusts the rate at which the frame source 304 generates frames. In some examples, the framerate adjustment unit 302 adjusts the rate at which the encoder 140 encodes frames directly, and in other examples, the framerate adjustment unit 302 adjusts the rate at which the encoder 140 encodes frames indirectly. Direct adjustment means controlling the rate at which the encoder 140 encodes frames separate from the rate at which the frame source 304 transmits frames to the encoder 140 (in which case, in some implementations, the encoder 140 drops some of the frames from the frame source 304). Indirect adjustment means that the framerate adjustment unit 302 adjusts the rate at which the frame source 304 transmits frames to the encoder 140, which affects the rate at which the encoder 140 generates frames. The various possible techniques for adjusting the framerate of either or both of the frame source 304 and the encoder 140 are referred to herein as the framerate adjustment unit 302 adjusting the framerate, or the framerate adjustment unit 302 setting the framerate.

To determine the framerate that the framerate adjustment unit 302 should set, the framerate adjustment unit 302 considers one or more factors, including: the available computing resources of the server 120, the bandwidth available for transmission to the client 150, other workloads being processed on the server 120, and also considers reprojection analysis. The available computing resources include computing resources, such as processing time, memory, storage, or other computing resources. Computing resources contribute to the ability of either or both of the frame source 304 or the encoder 140 to generate/receive frames or to encode frames. In some situations, the computing resources of the server 120 are shared among multiple clients. In an example, the server 120 services multiple clients, generating an encoded video stream for each client. Generating the encoded video stream for multiple clients consumes a certain amount of computing resources, and at any given time, it is possible for the server 120 to not have enough resources to generate frames at the rate needed for all clients. Thus the framerate adjustment unit 302 adjusts the framerate based on the available computing resources in accordance with reprojection scores for those clients. In one example, the framerate adjustment unit 302 considers all reprojection scores for all clients and reduces framerate for those clients that have higher reprojection scores and are more amenable to reprojection.

In an example, if the framerate adjustment unit 302 determines that in an upcoming time period, the amount of work scheduled to be performed is greater than the amount of work that can be performed based on the computing resources available on the server 120, the framerate adjustment unit 302 reduces the framerate for the frame source 304 and/or the encoder 140. In another example, the framerate adjustment unit 302 reduces the framerate for the frame source 304 and/or the encoder regardless of the degree to which the capacity is used on the server 120. In an example, the server 120 generates encoded video streams for multiple clients. In response to determining that there are not enough computing resources to render frames for all the clients at a desired framerate, the framerate adjustment unit 302 determines which client 150 to reduce the framerate for based on the reprojection analysis. If content for one or more clients 150 is deemed amenable to reprojection, then the framerate for those one or more clients is reduced.

The network connection to any particular client 150 has a bandwidth limit. In some examples, to meet this bandwidth limit, the encoder 140 performs reprojection analysis to identify portions of time during which encoding framerate can be reduced. More specifically, portions of a video that are more amenable to reprojection can have their framerate reduced, so that portions that are less amenable to reprojection can avoid a framerate reduction, in order to meet the bandwidth limit.

The reprojection analysis includes considering reprojection video characteristics in setting the framerate for video encoded for a particular client 150. Reprojection video characteristics are characteristics of the video related to how “amenable” the video is to reprojection at the client 150. Video that is “amenable” to reprojection is deemed to be aesthetically acceptable to a viewer when undergoing reprojection by the reprojection unit 310 after decoding by a decoder 170 in a client. 150.

Reprojection is the generation of a reprojected frame of video by the client 150, where the reprojected frame of video is not received from the server 120. The reprojection unit 310 generates a reprojected frame of video by analyzing multiple frames that are prior in time to the reprojected frame and generating a reprojected frame based on the analysis. Reprojection is contrasted with frame interpolation in that frame interpolation generates an intermediate frame between one frame that is earlier and one frame that is later in time. Frame interpolation generally introduces latency into display of the video, as the interpolated frame can only be displayed after the frame that is later in time is received. By relying on frames earlier than, but not subsequent to, a particular time corresponding to a reprojected frame, the reprojected frame does not introduce the same type of lag that is introduced by interpolated frames. An example technique for generating reprojected frames includes a reprojection technique that is based on motion information detected from previous frames. In some examples, the motion is extracted from encoded video (e.g., the motion information used for extrapolation includes the motion vectors from previous frames). In other examples, motion could be separate from the motion information used for video encoding and could be generated either on the server or on a client.

As described above, the framerate adjustment unit 302 determines how amenable video content is to reprojection in determining whether to adjust the framerate for a particular client. Several techniques for the framerate adjustment unit 302 to determine whether video content is amenable to reprojection are now discussed.

In a first technique for determining whether video content is amenable to reprojection, the video content comprises frames of graphical content generated by an application, such as a game, executing on the server 120. The application outputs, to the framerate adjustment unit 302, reprojection-friendliness metadata (also just called “reprojection metadata”) for each frame. The reprojection-friendliness metadata defines how amenable a particular frame is to reprojection.

In some implementations, the reprojection friendliness metadata is a score that indicates the degree to which the framerate can be reduced from the framerate displayed at the client 150. In other implementations, the reprojection friendliness metadata is a flag that indicates that the framerate can be reduced as compared with the framerate displayed at the client 150, where the reduction is done to a particular framerate designated as the reduced framerate.

The framerate displayed at the client 150 is the framerate of the video content sent from the server 120, modified based on whether reprojection is performed by the client 150. If reprojection at the client is performed.

An example technique for determining the reprojection friendliness metadata by the application is now described. In this example, the application running on the server considers one or more of the following factors in determining the reprojection friendliness metadata. One factor is determining the degree to which objects in a scene are moving in screen space or world space. With this factor, the more objects there are that are moving in different directions, and the greater the magnitude of their movement in screen space, the less friendly the scene will be to reprojection, which will be indicated in the reprojection friendliness metadata. Another factor is prediction of when an object that is visible will become not visible or when an object that is not visible will become visible. In some circumstances, an object that is visible becomes not visible when that object is occluded (behind) by another object or when that object leaves the view frustum (the volume of world space that the camera can see). In some circumstances, an object that is not visible becomes visible when the object enters the view frustum or when the object stops being occluded by another object. Scenes with this type of activity—objects leaving or entering view—are less amenable to reprojection, which will be indicated in the reprojection friendliness metadata. Another factor is presence of transparent objects, volumetric effects and other objects not amenable to reprojection. Another factor is knowledge of user activity in scenes that are otherwise amenable to reprojection. More specifically, a user input, such as a key/button press or mouse click, sometimes alters the scene, such as by moving or changing the trajectory of an object. Because this type of motion is not predictable by reprojection techniques, a situation in which a user is entering input indicates that the scene is in some circumstances not amenable to reprojection, which will be indicated in the reprojection friendliness metadata. Another factor is detecting a scene transition. Scene transitions represent abrupt changes in frames, and thus are not amenable to reprojection. Any other factors indicating amenability to reprojection are, in various implementations, alternatively or additionally be used.

In various implementations, any of the factors are combined to generate the reprojection friendliness metadata. In an example, the factors are associated with scores based on the factor indicating amenability of the scene to reprojection. In an example where the metadata is a flag, the scores are combined (e.g., added, weighted sum, or through any other technique) and tested against a threshold. The result of the test is used to set the flag. In an example where the metadata is a value, the scores are combined (e.g., added, weighted sum, or through any other technique) and the result indicates the degree to which framerate is reduced.

In a second technique for determining whether video content is amenable to reprojection, the framerate adjustment unit 302 analyzes the content of the video frames. In general, this technique attempts to determine how “dynamic” a scene is, where the term “dynamic” refers to the amount of motion from frame to frame. A scene with a large amount of chaotic motion will not be very amenable to reprojection, and a scene with a smaller amount of motion that is more regular, or a scene with no motion, will be more amenable to reprojection. The result of this analysis is reprojection friendliness metadata similar to the reprojection friendliness metadata obtained from the application, except that in this technique, the framerate adjustment unit 302 generates the reprojection friendliness metadata.

Some example operations by which the framerate adjustment unit 302 generates reprojection friendliness metadata are now described. The framerate adjustment unit 302 obtains motion vector data from the encoder 140 or obtains motion information independently of the motion vector data generated in the course of. Motion vectors are vectors that indicate, for each spatial subdivision (i.e., block) of an image, a direction and spatial displacement of a different spatial subdivision that includes similar pixels. In an example, in one frame, a spatial subdivision is assigned a motion vector indicating the position of a block of pixels that is sufficiently similar to the pixels in the spatial subdivision. A single frame includes a large number of motion vectors. In this operation, the framerate adjustment unit 302 derives the reprojection friendliness metadata from the motion vectors. In one example, the framerate adjustment unit 302 generates the metadata based on the degree of diversion of the motion vectors. Diversion of the motion vectors means the difference in magnitude, direction, or both, in the motion vectors. The diversion is calculated in any technically feasible manner. In an example, a statistical measure of one or both of the magnitude or direction, such as standard deviation, is taken. The framerate adjustment unit 302 sets the value of the reprojection friendliness metadata to a value associated with the statistical measure. In an example where the reprojection friendliness metadata is a flag, if the statistical measure is above (or below) a threshold, then the framerate adjustment unit 302 sets the friendliness metadata to indicate that the content is not (or is) amenable to being reprojected. In an example where the reprojection friendliness metadata is a value that can vary and that indicates the degree to which the framerate can be reduced, the framerate adjustment unit 302 sets the friendliness metadata to a value that is based on (such as inversely proportional to or proportional to) the statistical measure.

In some implementations, the framerate adjustment unit 302 determines the friendliness metadata based on an image segmentation technique that segments the image based on color, depth, and/or another parameter. Depth is a construct within a graphics rendering pipeline. Pixels have a depth—a distance from the camera—associated with the triangle from which those pixels are derived. In some implementations, image segmentation results in multiple portions of an image, segmented based on one of the above parameters. The framerate adjustment unit 302 obtains a characteristic motion vector (such as an average motion vector) for each portion. If the characteristic motion vectors for the different portions of the image are sufficiently different (e.g., the standard deviation(s) of motion vector magnitude, direction, or both are above threshold(s)), then the framerate adjustment unit 302 determines that the video is not amenable to reprojection. In one example, the framerate adjustment unit 302 segments the image into different groups of pixels based on depth. More specifically, each group includes pixels having a specific range of depths (e.g., some pixels have a near depth and some pixels have a far depth, and so on). Then, for different blocks in the image, the framerate adjustment unit 302 obtains motion vectors for each group of pixels in that block. The framerate adjustment unit 302 analyzes the per-depth-segment, per-block motion vectors to obtain an estimate of parallax, and, optionally, of object occlusion and disocclusion based on parallax at the given depth in the scene. In an example, the framerate adjustment unit 302 detects different motion vectors for adjacent blocks of an image. Without consideration for depth it might appear as if objects covered by those image blocks would produce significant disocclusion of objects. Taking the depth into consideration, it could be more accurately determined if disocclusion would occur. In an example, a disocclusion measure is the percentage of image area where disocclusion occurs. In another example, the disocclusion measure is further corrected for distance or locality of disocclusion within a frame. In an example, objects moving at drastically different distances to the camera will have a higher likelihood of producing disocclusion, unless those objects move in a perfectly circular motion around the camera. Thus, in this example, the disocclusion measure is greater with objects that are moving and are at depths that differ by a threshold (e.g., threshold percentage or threshold fixed value) and is lower for objects that are not moving or that are within the depth threshold of each other. In another example, the disocclusion measure increases as the degree to which depth of the various objects changes increases and decreases as the degree to which depth of the various objects changes decreases. In yet another example, the framerate adjustment unit 302 generates motion vectors for image fragments (image portions) by determining, based on the temporal rate of depth change for the fragments and image-space motion for the fragments, an expected position in three-dimensional space. The framerate adjustment unit 302 then projects the predicted three-dimensional positions into the two-dimensional space of the image and identifies the disocclusion measure based on such projections.

If the disocclusion measure is above a certain threshold, the framerate adjustment unit 302 determines that the video is not amenable to reprojection. Although one technique for determining a parallax-corrected disocclusion measure is described, any technically feasible technique could be used. In addition, although segmentation based on depth is described, it is possible to segment video based on factors other than depth, such as color or another parameter, to obtain a measure analogous to the parallax measure based on such segmentation, and to determine whether the video is amenable to reprojection based on that measure.

In some implementations, generation of the reprojection friendliness metadata from analysis of the video data is performed using a machine learning module. In an example, a machine learning module is a machine-learning-trained image recognition module that correlates input video with reprojection friendliness metadata. In some examples, such an image recognition module is trained by providing pairs consisting of input video and classifications, where the classifications are pre-determined reprojection friendliness metadata for the input image. In other examples, the machine learning module segments images to allow the above segmentation-based analysis to occur. In such examples, the machine learning module is trained by providing input video and segmentation classifications. In yet other examples, the machine learning module is trained to recognize scene changes (which, as described above, are considered not amenable to reprojection). To train such a machine learning module, training data including input video and classifications consisting of whether and where the input video has a scene change is provided to the machine learning module. In still another example, the machine learning module is trained to accept a variety of inputs, such as a reprojection friendliness score determined as described elsewhere herein, image detection results from a different machine learning module, and one or more other factors, and to generate a revised reprojection friendliness score in response. In various implementations, the machine learning module is a hardware module (e.g., one or more circuits), a software module (e.g., a program executing on a processor), or a combination thereof.

FIG. 4 is a flow diagram of a method 400 for setting the framerate for an encoded video stream, according to an example. Although described with respect to the systems of FIGS. 1A-3, it should be understood that any system, configured to perform the steps of the method 400 in any technically feasible order, falls within the scope of the present disclosure.

The method 400 begins at step 402, where the framerate adjustment unit 302 determines that reprojection analysis should occur. In some implementations, the server 120 always performs reprojection analysis to determine when it is possible to reduce the server 120 processing load and/or to reduce bandwidth consumption by finding content where the framerate can be reduced. In other implementations, the server 120 performs reprojection analysis in response to determining that bandwidth to a client 150 is insufficient for video being encoded. In other implementations, the server 120 performs reprojection analysis in response to determining that there is contention for the system resources of the server 120.

As described above, in some implementations, reprojection analysis should occur in the situation that there is contention for system resources of the server 120. Contention for system resources exists if there is a pending amount of work that exceeds the capacity of the server 120 to perform in an upcoming time frame. More specifically, contention for system resources exists if there is total amount of work that needs to be performed for a set of threads executing on the server 120 in a certain future time frame and that amount of work cannot be executed in the future time frame due to an insufficiency in the number of a particular computing resource. The term “thread” refers to any parallelized execution construct, and in various circumstances includes program threads, virtual machines, or parallel work tasks to be performed on non-CPU devices (such as a graphics processor, an input/output processor, or the like). In an example, contention for system resources exists if a total number of outstanding threads cannot be scheduled for execution on the server 120 for a sufficient amount of execution time to complete all necessary work in the future time frame. In another example, there is not enough of a certain type of memory (e.g., cache, system memory, graphics memory, or other memory) to store all of the data needed for execution of all work within the future time frame. In another example, there is not enough of a different resource, such as an input/output device, an auxiliary processor (such as a graphics processing unit), or any other resource, to complete the work in the future time frame.

In some examples, the server 120 determines that there are insufficient computer resources for performing a certain amount of work in an upcoming time frame by detecting that the server 120 was unable to complete at least one particular workload in a prescribed prior time frame. In an example, the server 120 executes three-dimensional rendering for multiple clients 150. In this example, a certain framerate target (such as 60 frames per second (“fps”)) is set, giving each frame a certain amount of time to render (e.g., 1/60 seconds=˜16.7 milliseconds). In this example, if at least one three-dimensional rendering workload does not finish rendering a frame within this time to render, then the framerate adjustment unit 302 determines that there is system resource contention. In this scenario, in some implementations, a task of the framerate adjustment unit 302 is to determine one or more clients 150 to decrease the framerate for, based on the analysis performed by the framerate adjustment unit 302 as described elsewhere herein.

In another example, reprojection analysis should occur in the situation that the bandwidth from the server 120 to the client 150 receiving the video under consideration for reprojection analysis is insufficient for the video. In such situations, the server 120 identifies time periods during which to reduce framerate based on reprojection analysis.

In another example, reprojection analysis always occurs, as a means to determine how to reduce computer resource utilization at the server 120 and/or bandwidth utilization in the network connection between server 120 and client 150.

At step 404, the framerate adjustment unit 302 generates reprojection metadata based on the suitability of video content to reprojection. Any of the techniques described herein, or any other technically feasible technique, are capable of being used for this purpose. Further, in some implementations, the reprojection friendliness metadata is a flag that indicates whether the framerate of the video content is to be reduced from a desired value or not. In other implementations, the reprojection friendliness metadata is a value that indicates the degree to which the framerate of the video content is to be reduced from the desired value.

As discussed elsewhere herein, in some implementations, the framerate adjustment unit 302 obtains the reprojection friendliness metadata from the application generating the content to be encoded. In such examples, the application generates the reprojection friendliness metadata based on application context data, such as data derived from the movement of objects in screen space or world space, data indicative of whether objects will go in or out of view, data indicative of user inputs, or data indicative of scene transitions. Additional details regarding such techniques are provided elsewhere herein. In other implementations, the framerate adjustment unit 302 analyzes the content of the frames to be encoded to generate the reprojection friendliness metadata. Various techniques for generating the reprojection friendliness metadata in this manner are disclosed herein, such as through consideration of motion vectors, through scene deconstruction, and with the use of machine learning techniques. The resulting reprojection friendliness metadata indicates whether a particular video is amenable to reprojection and thus serves as a directive to the encoder 140 and possibly to the frame source 304 that indicates whether and/or to what degree to reduce the framerate of video as compared with an already-set framerate.

At step 406, the encoder 140, and possibly the frame source 304, generates the video according to the reprojection metadata. In an example, the frame source 304 is an application and/or three-dimensional rendering hardware. If the reprojection metadata indicates that framerate is to be reduced, then the framerate adjustment unit 302 causes the frame source 304 to reduce the rate at which frames are generated, which also results in the encoder 140 reducing the rate at which frames are encoded. The client 150 would cause reprojection to occur when that reduced framerate video is received. In another example, the frame source 304 is simply a video content receiver and has no means to reduce the rate at which frames are generated. In that example, the framerate adjustment unit 302 causes the frame source 304 to reduce the rate at which frames are transmitted to the encoder 140 and/or causes the encoder 140 to reduce the rate at which frames are encoded.

At step 408, the server 120 transmits the encoded video and optional information about reprojection (“reprojection metadata”) to the client 150 for display. In situations where the framerate has been reduced below what the client 150 is set to display, the client 150 performs reprojection to generate additional frames for display.

It should be understood that many variations are possible based on the disclosure herein. Although features and elements are described above in particular combinations, in various implementations, each feature or element is used alone without the other features and elements or in various combinations with or without other features and elements.

The various functional units illustrated in the figures and/or described herein (including, but not limited to, the processor 102, the input driver 112, the input devices 108, the output driver 114, the output devices 110, the encoder 140 or the decoder 170 or any of the blocks thereof, the framerate adjustment unit 302, the frame source 304, or the reprojection unit 310) are, in various implementations, implemented as a general purpose computer, a processor, or a processor core, or as a program, software, or firmware, stored in a non-transitory computer readable medium or in another medium, executable by a general purpose computer, a processor, or a processor core. The methods provided are, in various implementations, implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors are, in various implementations, manufactured by configuring a manufacturing process using the results of processed hardware description language (HDL) instructions and other intermediary data including netlists (such instructions capable of being stored on a computer readable media). The results of such processing include maskworks that are then used in a semiconductor manufacturing process to manufacture a processor which implements aspects of the embodiments.

In various implementations, the methods or flow charts provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for generating encoded video, the method comprising:
determining that reprojection analysis should occur;
generating reprojection metadata based on suitability of video content to reprojection;
generating encoded video based on the reprojection metadata; and
transmitting the encoded video to a client for display.

2. The method of claim 1, wherein determining that reprojection analysis should occur comprises determining that contention exists for system resources at the server.

3. The method of claim 2, wherein determining that contention exists for system resources at the server comprises:
determining that an amount of work to be performed by the server cannot be completed in a pre-defined time frame.

4. The method of claim 1, wherein generating the reprojection metadata comprises:
generating the reprojection metadata by an application executed on the server that generates the encoded video data, wherein the application generates the video content.

5. The method of claim 4, wherein generating the reprojection metadata by the application is based on one or more of object movement, object visibility, scene change, or user input.

6. The method of claim 1, wherein generating the reprojection metadata comprises:
generating the reprojection metadata by analyzing the pixel content of the video content.

7. The method of claim 6, wherein analyzing the pixel content comprises performing motion vector analysis.

8. The method of claim 1, wherein the reprojection metadata comprises a flag that indicates whether to reduce framerate for the video content as compared with a framerate set for display for a user.

9. The method of claim 1, wherein the reprojection metadata comprises a value that indicates a degree to which to reduce framerate for the video content as compared with a framerate set for display for a user.

10. A server for generating encoded video, the server comprising:
an encoder; and
a framerate adjustment unit, configured to:
determine that reprojection analysis should occur; and
generate reprojection metadata based on suitability of video content to reprojection,
wherein the encoder is configured to:
generate encoded video based on the reprojection metadata; and
transmit the encoded video to a client for display.

11. The server of claim 10, wherein determining that reprojection analysis should occur comprises determining that contention exists for system resources at the server.

12. The server of claim 11, wherein determining that contention exists for system resources at the server comprises:
determining that an amount of work to be performed by the server cannot be completed in a pre-defined time frame.

13. The server of claim 10, wherein generating the reprojection metadata comprises:
generating the reprojection metadata by an application executed on the server that generates the encoded video data, wherein the application generates the video content.

14. The server of claim 13, wherein generating the reprojection metadata by the application is based on one or more of object movement, object visibility, scene change, or user input.

15. The server of claim 10, wherein generating the reprojection metadata comprises:
generating the reprojection metadata by analyzing the pixel content of the video content.

16. The server of claim 15, wherein analyzing the pixel content comprises performing motion vector analysis.

17. The server of claim 10, wherein the reprojection metadata comprises a flag that indicates whether to reduce framerate for the video content as compared with a framerate set for display for a user.

18. The server of claim 10, wherein the reprojection metadata comprises a value that indicates a degree to which to reduce framerate for the video content as compared with a framerate set for display for a user.

19. A non-transitory computer-readable medium storing instructions that, when executed by a processor, cause the processor to generate encoded video, by:
determining that reprojection analysis should occur;
generating reprojection metadata based on suitability of video content to reprojection;
generating encoded video based on the reprojection metadata; and
transmitting the encoded video to a client for display.

20. The non-transitory computer-readable medium of claim 19, wherein generating the reprojection metadata comprises:
generating the reprojection metadata by analyzing the pixel content of the video content.
